(19) United States
(12) Patent Application Publication
(10) Pub. No.: US 2013/0339481 A1
(43) Pub. Date: Dec. 19, 2013

(54) METHOD FOR CONTENT DISCOVERY OF NODE IN INTRA-DOMAIN AND INTER-DOMAIN IN CONTENT CENTRIC NETWORK AND NODE THEREFOR

(71) Applicant: SAMSUNG ELECTRONICS CO., LTD., Suwon-si (KR)

(72) Inventors: Seong Ik HONG, Suwon-si (KR); Do Jun BYUN, Seoul (KR); Byoung Joon LEE, Seongnam-si (KR); Myeong Wuk JANG, Hwaseong-si (KR); Jae Hoon KIM, Yongin-si (KR)

(73) Assignee: SAMSUNG ELECTRONICS CO., LTD., Suwon-si (KR)

(21) Appl. No.: 13/914,891

(22) Filed: Jun. 11, 2013

(30) Foreign Application Priority Data
Jun. 11, 2012 (KR) 10-2012-0062147
May 13, 2013 (KR) 10-2013-0053778

(51) Int. Cl. H04L 29/08

(52) U.S. Cl. CPC H04L 67/16
USPC 709/217

(57) ABSTRACT

A method for content discovery of a node in an intra-domain in a content centric network (CCN), includes generating a content request packet including a discovery area in which a search for content requested from the node is to be conducted, and transmitting the content request packet.

### CROSS-REFERENCE TO RELATED APPLICATIONS

This application claims the benefit under 35 USC 119(a) of Korean Patent Application No. 10-2012-0062147, filed on Jun. 11, 2012, and Korean Patent Application No. 10-2013-0053778, filed on Mar. 13, 2013, in the Korean Intellectual Property Office, the entire disclosures of which are incorporated herein by reference for all purposes.

### BACKGROUND

1. Field

The following description relates to a method for content discovery of a node in an intra-domain and an inter-domain in a content centric network (CCN) and a node therefor.

2. Description of Related Art

In a content centric network (CCN), packets are classified into content request packets and content reply packets. A content request packet, also referred to as an interest packet, includes a name of a requested content. A content reply packet includes a requested content and a name of the requested content.

When a network device receives a content request packet from a requester, the network device may look up a storage space of the network device by a name of a requested content in a header of the content request packet. When the corresponding requested content is present in the storage space, the network device may deliver the corresponding requested content to the requester. Unlike in an Internet Protocol (IP)-based network, in which content may be obtained from an original owner of the content, in a CCN, any intermediate node, in which a requested content is cached in a storage space, may send a content reply packet. Accordingly, an average length of a transmission path may be reduced, and as a result, overall usage of the CCN may be reduced.

### SUMMARY

In one general aspect, there is provided a method for content discovery of a node in an intra-domain in a content centric network (CCN), the method including generating a content request packet including a discovery area in which a search for content requested from the node is to be conducted, and transmitting the content request packet.

In another general aspect, there is provided a method for content discovery of a node in an inter-domain in a content centric network (CCN), the method including determining whether another domain transmitting a content request packet to the node is associated with a policy, and searching for content stored in the node based on a result of the determination. The method further includes transmitting the content stored in the node in response to the content stored in the node matching content requested from the other domain.

In still another general aspect, there is provided a node for content discovery in an intra-domain in a content centric network (CCN), the node including a packet generating unit configured to generate a content request packet including a discovery area in which a search for content requested from the node is to be conducted, and a transmitting unit configured to transmit the content request packet.

Other features and aspects will be apparent from the following detailed description, the drawings, and the claims.

### BRIEF DESCRIPTION OF THE DRAWINGS

FIG. 1 is a diagram illustrating an example of a method of requesting content and providing content in response to the request in a content centric network (CCN).

FIG. 2 is a diagram illustrating an example of a CCN including inter-domain routing and intra-domain routing for content discovery.

FIG. 3 is a diagram illustrating an example of an inter-domain network.

FIG. 4 is a flowchart illustrating an example of a routing method for content discovery across an inter-domain network in a CCN.

FIG. 5 is a flowchart illustrating another example of a routing method for content discovery across an inter-domain network in a CCN.

FIG. 6 is a diagram illustrating an example of an intra-domain network environment in which a method for content discovery of a node is performed in a CCN.

FIG. 7 is a diagram illustrating an example of a configuration and an area-based hierarchy of the intra-domain network environment of FIG. 6.

FIG. 8 is a flowchart illustrating an example of a routing method for content discovery across an intra-domain network in a CCN.

FIG. 9 is a flowchart illustrating an example of a method for content discovery of a node in a CCN.

FIG. 10 is a flowchart illustrating an example of a method of forming an association with an access point in a CCN.

FIG. 11 is a diagram illustrating an example of an operation of a node for content discovery over a native L2 in a CCN.

FIG. 12 is a diagram illustrating an example of a format of a content request packet based on a method for content discovery of a node in a CCN.

FIG. 13 is a diagram illustrating an example of an operation of a node for content discovery over an Internet Protocol (IP) in a CCN.

FIG. 14 is a block diagram illustrating an example of a node for content discovery in a CCN.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

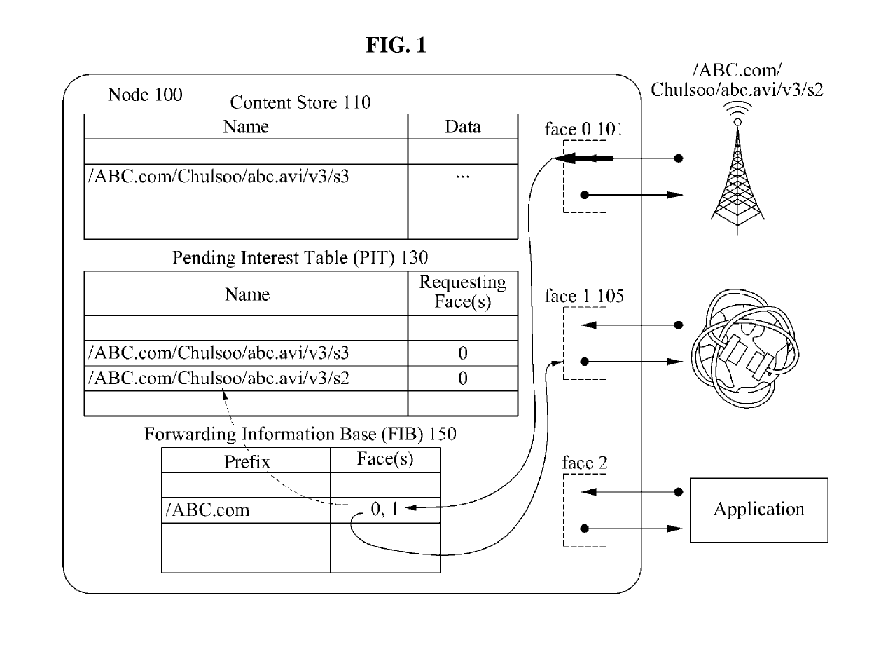

FIG. 1 illustrates an example of a method of requesting content and providing content in response to the request in a content centric network (CCN). In the CCN or an information centric network (ICN), a name of content functions as a compass to find a node in which the corresponding content is stored, and functions to distinguish the corresponding content from other content. Accordingly, each content includes a unique name, and contents including different names may be regarded as different contents even though the same information is included in the contents. For example, when two files include the same information, but include different names, for example, “/ABC.com/sait/video/intro.avi” and “/ABC.com/sait/comm/video/intro.avi”, the two files are processed as different contents. This rule is useful in distinguishing different contents with similar names.

In FIG. 1, a method of processing a content request packet based on a hierarchical name of a content included in the content request packet in a CCN is illustrated. For example, a node 100 included in the CCN receives, via a face 0 101 from, for example, another node, the content request packet requesting the content corresponding to the hierarchical name of the content, for example, “/ABC.com/Chulsoo/abc.avi/v3/s2”. As used herein, the term “face” may be interchangeable with the term “interface”.

A networking module of the node 100 determines whether the corresponding content is included in a content store 110 of the node 100 based on whether an entry stored with the same hierarchical name of the content, “/ABC.com/Chulsoo/abc.avi/v3/s2”, is included in the content store 110. The content store 110 may be also referred to as a content cache. When the corresponding content is determined to be included in the content store 110, the node 100 returns the corresponding content to the face 0 101 used to receive the content request packet.

In contrast, when the corresponding content is determined to be absent in the content store 110, as shown in FIG. 1, the node 100 determines whether an entry stored with the same hierarchical name of the content, “/ABC.com/Chulsoo/abc.avi/v3/s2”, is included in a Pending Interest Table (PIT) 130 of the node 100. When the entry stored with the same hierarchical name of the content is determined to be included in the PIT 130, as shown in FIG. 1, the node 100 adds information ‘0’ of the face 0 101, namely, a requesting face, to the corresponding entry in the PIT 130.

When the entry stored with the same hierarchical name of the content is determined to be absent in the PIT 130, the node 100 further searches for the corresponding entry by performing a lookup of an entry in a Forwarding Information Base (FIB) 150 based on the hierarchical name of the content. In this example, the node 100 conducts a search for the entry, using longest prefix matching of a longest prefix of the hierarchical name of the content, “/ABC.com”, with a prefix included in the entry.

Subsequently, the node 100 determines a face to be used to forward the content request packet, in this example, a face 1 105, based on information of the face that is registered in the entry of the FIB 150. The node 100 transmits the content request packet to the face 1 105, which may forward the content request packet to another node.

In this example, the node 100 registers, in the entry of the FIB 150, information ‘0’ of the face 0 101 used to receive the content request packet. The registration is performed to deliver a data packet including a content to another node requesting the content when a content request packet is received in the future. Additionally, another face, other than the face 1 105, may be selected or determined based on the FIB 150 to be used to forward content request packet.

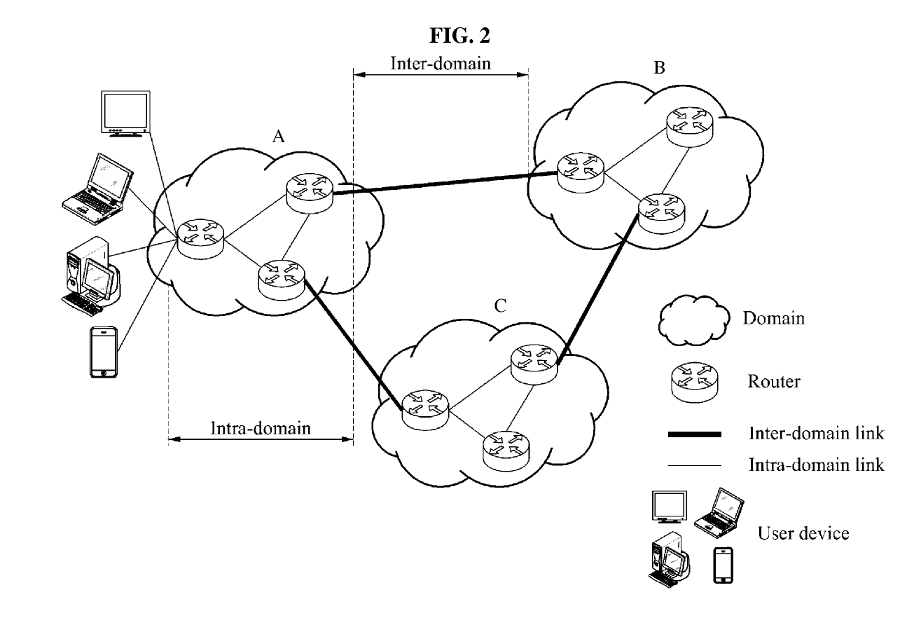

FIG. 2 illustrates an example of a CCN including inter-domain routing and intra-domain routing for content discovery. Referring to FIG. 2, a routing method in the CCN may use an area-based hierarchy, similar to an Internet Protocol (IP)-based network. In the CCN, the area-based hierarchy includes an inter-domain and an intra-domain based on routing areas, and the routing method includes the inter-domain routing and the intra-domain routing.

Referring to FIG. 2, the term “inter-domain routing” refers to routing between different domains, for example, a domain A and a domain B, and the term “intra-domain routing” refers to routing between network devices, for example, routers, within a domain, for example, the domain A. A domain may be an autonomous system (AS), and may be managed by an Internet service provider (ISP). The inter-domain routing includes at least one inter-domain link, and the intra-domain routing includes at least one intra-domain link. Each of the routers may be connected to at least one user device.

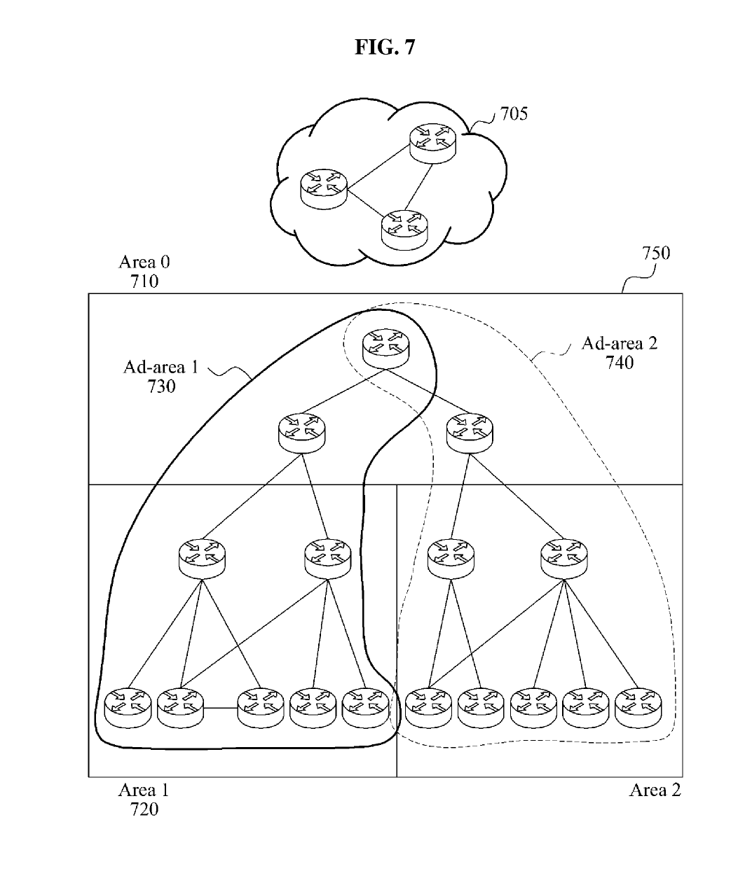

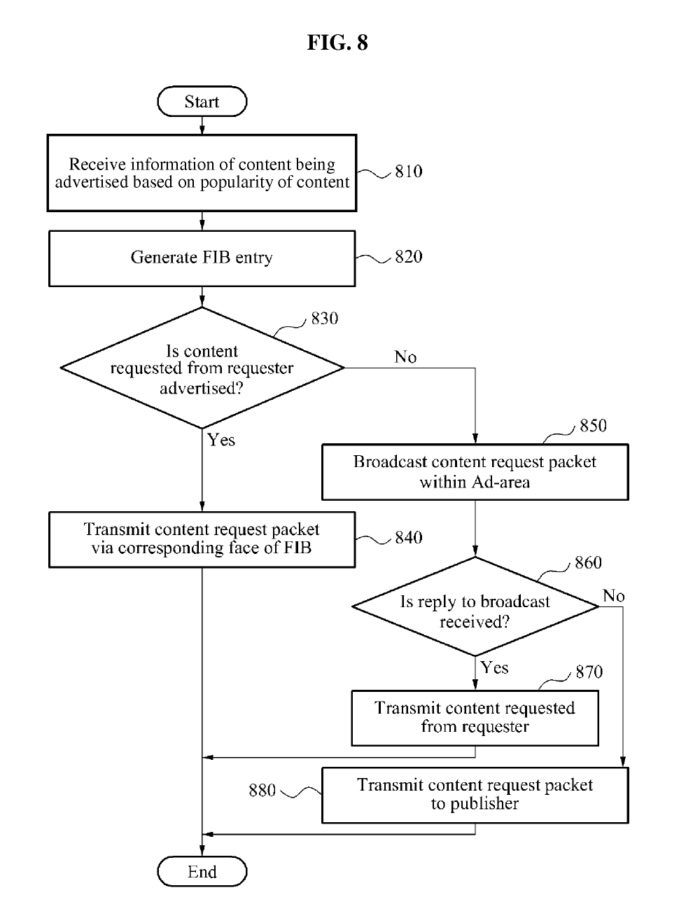

Different routing approaches may be applied to the inter-domain and the intra-domain. For example, hybrid routing may be applied to the intra-domain. The term “hybrid routing” includes content-level routing and publisher-level routing. A further detailed description of the hybrid routing is provided with reference to FIGS. 7 and 8.

The CCN may be configured as an IP overlay or as a CCN layer upon a native layer 2 (L2). The routing method may be applied to the two configurations.

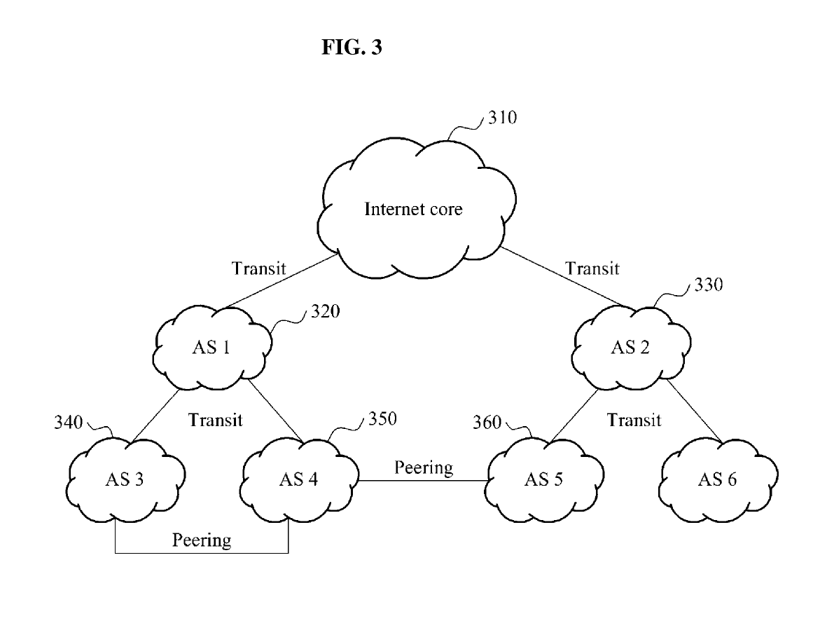

FIG. 3 illustrates an example of an inter-domain network. Referring to FIG. 3, each domain of the inter-domain network may be an autonomous system (AS), and may be assigned a natural number from 0 to 65,535 as an identification (ID).

In a connection to an Internet core 310 through an AS, a connection between ASs may be termed a “transit”. For example, in FIG. 3, a connection between an AS 1 320 and an AS 4 350, or a connection between an AS 2 330 and an AS 5 360, may be a transit.

Also, a connection between ASs independent from a connection to the Internet core 310 may be termed a “peering”. For example, in FIG. 3, a connection between an AS 3 340 and the AS 4 350, or a connection between the AS 4 350 and the AS 5 360, may be a peering.

A routing method may be primarily implemented for a transit. A transit between ASs allows an AS connected to the Internet core 310 to provide a disconnected AS with connectivity to the Internet core 310, and hence, may be known as a relation of a customer and a provider. For example, the AS 1 320 providing connectivity to the Internet core 310 may be referred to as a provider AS, and the AS 3 340 and the AS 4 350 connected to the Internet core 310, using the AS 1 320 as a transit AS, may be referred to as a customer AS.

In an IP-based network, the AS 1 320 may transmit an IP packet. For this purpose, a customer AS may determine whether a packet is to be transmitted based on a policy between ASs. The ASs may set the policy, and may exchange information of the policy.

However, in a CCN, a cache hit for a content cache may be a factor as well as a packet transmission. This concern may be only associated with a transit AS because whether a cache hit for a content cache is permitted in a transit AS is one of factors determining an amount of link usage between the transit AS and an Internet core. However, when a cache hit for the content cache is permitted, a response time taken to respond to a request from a customer AS may be reduced to improve a satisfaction level of a user of the customer AS. Accordingly, in examples, whether a cache hit for the content cache is permitted in the transit AS, a level in which a cache hit ratio in the content cache of the transit AS needs to be maintained, and a cache size to be allocated to an AS, may be policies.

In inter-domain routing, routing information including policy information between domains or ASs may be exchanged using a sync tree. The sync tree may include connectivity information, for example, routing information, between a domain in which a corresponding node is included and another domain. A method of exchanging the routing information between the domains, or a method of applying a policy, may be similar to those used in an IP-based network, and thus a detailed description is omitted herein.

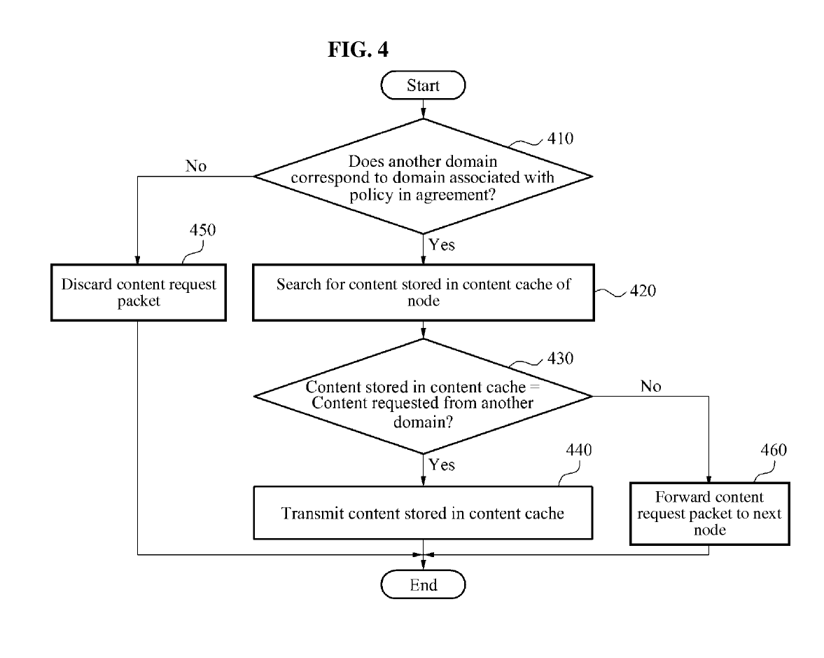

FIG. 4 illustrates an example of a routing method for content discovery across an inter-domain network in a CCN. Referring to FIG. 4, in operation 410, a node included in a domain of the inter-domain network determines whether another domain corresponds to a domain associated with a policy in agreement, when the node receives a content request packet from the other domain. The policy may include at least one domain agreed to in a cache look-up contract, a contract for a cache hit ratio, and/or a contract for a cache size to be allocated, including the domain in which the node is included.

The cache look-up contract may be for access to content stored in a content cache of a corresponding node, namely, for permission for a cache hit. The cache hit ratio contract may be for a hit ratio of content being provided. For example, if music content and movie content are located in a domain A, the domain A may provide 40% of the music content and 60% of the movie content to a domain B contracted with the domain A.

The content request packet may include a field indicating a domain by which the content request packet is generated. Accordingly, the field may be used to determine whether the other domain is associated with the policy in agreement. For example, if the domain A agrees with the domain B, in which a node X is included, about a cache look-up contract and/or a contract for a cache hit ratio, the domain A may set the domain A or information of the domain A in a field of a content request packet that indicates a domain, to indicate that the content request packet is transmitted from the domain A when the content request packet is transmitted to the domain B. Accordingly, the domain B may recognize that the content request packet is transmitted from the domain A based on the information set in the field, and may accept the cache look-up contract or the contract for the cache hit ratio for the content request packet. For this purpose, for example, the node X may exchange routing information and other information, with the domain A, based on the policy in agreement, using a sync tree including connectivity information between the domain B and the domain A.

When the other domain is determined to be associated with the policy in agreement, the node continues in operation 420. Otherwise, the node continues in operation 450.

In operation 420, the node searches for a content stored in a content cache of the node.

In operation 450, the node discards the content request packet received from the other domain, without forwarding the content request packet to a next node. The node ends the method. The next node may be within the same domain as the node or a different domain from the node.

In operation 430, the node determines whether the content stored in the content cache matches a content requested from the other domain based on the content request packet. When the content stored in the content cache is determined to match the content request from the other domain, the node continues in operation 440. Otherwise, the node continues in operation 460.

In operation 440, the node transmits the content stored in the content cache to the other domain.

In operation 460, the node forwards the content request packet to the next node. Also, the node may exchange, with the other domain, routing information based on the policy in agreement, using sync tree including connectivity information between the domain and the other domain.

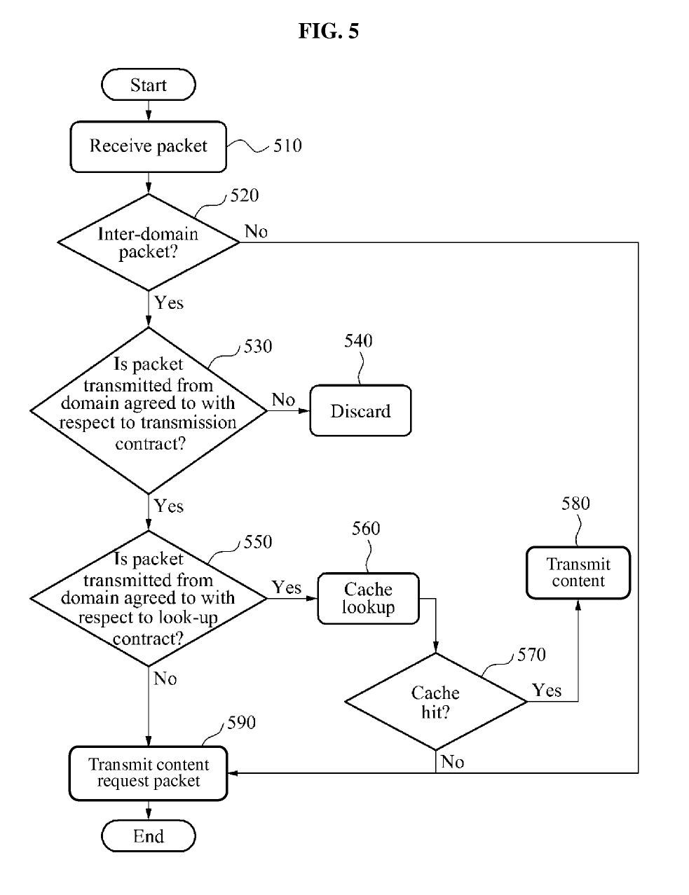

FIG. 5 illustrates another example of a routing method for content discovery across an inter-domain network in a CCN. Referring to FIG. 5, in operation 510, a node included in a domain receives a packet from another domain.

In operation 520, the node determines whether the packet is an inter-domain packet between domains. When the packet is determined to be an inter-domain packet, the node continues in operation 530. Otherwise, the node continues in operation 590.

In operation 530, the node determines whether the inter-domain packet is transmitted from a domain agreed to with respect to a contract for packet transmission. If the other domain is determined to be agreed to in the contract for the packet transmission, the node continues in operation 550. Otherwise, the node continues in operation 540.

In operation 540, the node discards the inter-domain packet.

In operation 550, the node determines whether the inter-domain packet is transmitted from a domain agreed to with respect to a cache look-up contract. If the other domain is determined to be agreed to in the contract for the cache look-up contract, the node continues in operation 560. Otherwise, the node continues in operation 590.

In operation 560, the node performs a cache look up of a content stored in a content cache of the node.

In operation 570, the node determines whether there is a cache hit, namely, whether the content stored in the content cache matches a content requested from the other domain based on the inter-domain packet. When it is determined there is the cache hit, the node continues in operation 580. Otherwise, the node continues in operation 590.

In operation 580, the node transmits the content stored in the content cache to the other domain.

In operation 590, the node forwards the content request packet to a next node.

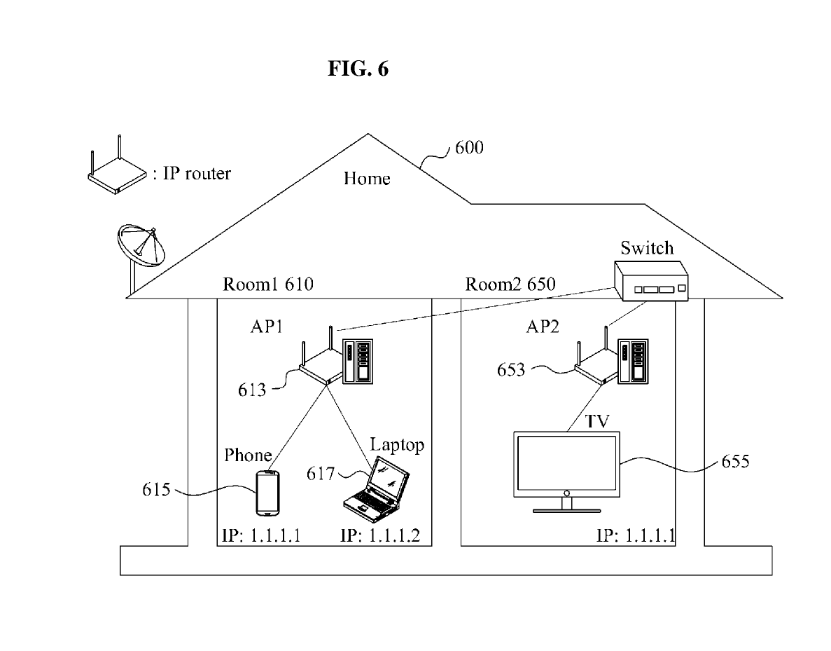

FIG. 6 illustrates an example of an intra-domain network environment in which a method for content discovery of a node is performed in a CCN. Referring to FIG. 6, a home network including access points is illustrated. Devices or nodes associated with each access point may be assigned private IP addresses (e.g., IP: 1.1.1.1 and IP: 1.1.1.2) from each access point. Each access point may be used as an IP router, and may drop broadcast or multicast traffic. An IP router may drop the broadcast or multicast traffic because most device/service discovery protocols use broadcast or multicast traffic.

In this example, within a home 600, an access point 1 AP1 613 located in a room 1 610 may disallow a packet, for example, a multicast/broadcast discovery packet, to be transmitted from a phone 615 associated with the AP1 613. The phone 615 may be connected to a laptop computer 617 associated with the AP1 613, but may not be connected to a TV 655 associated with an access point 2 AP2 653 located in a room 2 650, even though the AP1 613 is connected to the AP2 653 via a switch. This is caused by multicast/broadcast traffic used for device/service discovery being dropped by an access point.

In an example of an AllShare service, a discovery scope for Universal Plug and Play (UPnP) may be limited to a coverage area of an IP router or an access point, in this example, the room 1 610 or the room 2 650, according to characteristics of multicast. Accordingly, a method of distinguishing the room 1 610 from the room 2 650 within the home 600 may be needed. Also, a method of discovering a device associated with a different access point in the home 600 may be needed.

FIG. 7 illustrates an example of a configuration and an area-based hierarchy of the intra-domain network environment of FIG. 6. Referring to FIG. 7, a configuration of a network within a domain, which is also referred to as an intra-domain network 705, and an area-based hierarchy 750 of the intra-domain network 705, are shown.

Routers of an IP-based intra-domain network may be classified by area, and routing information may be exchanged only within each area. In this example, an area 0 710 is of a core router operating in a backbone, and an area 1 720 is of an IP router.

Area classification may also be done in a CCN or ICN. The area classification may be based on a size of a domain being not expected to reduce in view of an IP-based intra-domain network being currently used, and may be intended to ensure intra-domain routing scalability to exchange routing information. Accordingly, the area-based hierarchy 750 is used.

However, in the CCN, a forwarding information base (FIB) may be constructed to transmit a content request packet. The FIB may be configured from discovery or advertisement information or registration information being received for contents, but advertising all of the contents may be impossible with respect to scalability. Because a large amount of various types of contents are present and keep increasing, when all of the contents are advertised, a massive amount of advertisement information may cause network paralysis.

Accordingly, to ensure scalability, a content discovery area may be limited to an area, in this example, a discovery area or an advertisement area. The discovery area or the advertisement area, abbreviated to “Ad-area”, may be an area in which people with interests in similar contents gather in, e.g., buildings on a campus, an apartment complex, and/or an educational service district, and may range from such an area to core routers connected to an Internet core. For example, an Ad-area 1 730 may be an area in which people with interests in education related contents, education related services, and/or an education service providing apparatus gather, and an Ad-area 2 740 may be an area in which people with interests in sports and travel related contents and/or services among education related contents and/or services gather. Accordingly, content sharing efficiency in a narrow area may be improved by confining a content discovery area to a limited range.

Also, the discovery area may be used to locate a non-requested content. A broadcast area of a content request packet may be localized by allowing a broadcast in the discovery area. Additionally, the discovery area may be used to maintain scalability of the CCN.

Various examples of content discovery are described below. When content mapping is configured between a router and a terminal, content discovery may be needed. A discovery scope may be limited to popular content. Content discovery including or excluding content aggregation may be determined in units of individual content, and/or may be determined based on properties of content.

Also, for transiently cached content, content discovery may be performed on only content including a predetermined period of life or longer. Content discovery may not be performed on temporarily cached content.

Further, to adjust an amount of discovery messages, a popularity level of content to be discovered may be adjusted based on an amount of discovery messages. An amount of control traffic associated with content discovery may be maintained uniformly.

In an intra-domain network, routing of discovered content may use, for example, a shortest path first method of open shortest path first (OSPF) for the Internet being currently used.

FIG. 8 illustrates an example of a routing method for content discovery across an intra-domain network in a CCN. Referring to FIG. 8, in operation 810, a node receives information of a content being advertised based on a popularity of the content. The popularity of the content may be determined based on an access count of the content. When a number of content request packets for the content is greater than or equal to a preset value, the content may be determined to be popular, namely, popular content. The information of the content may include a list of content names stored in a content cache of a provider.

In operation 820, the node generates an FIB entry for the content based on the information of the content.

In operation 830, the node determines whether a content requested from a requester is advertised, based on whether the content requested from the requester matches the content in the FIB entry. When the content requested from the requester is determined to be advertised, the node continues in operation 840. Otherwise, the node continues in operation 850.

In operation 840, the node transmits a content request packet to the provider advertising the content in the FIB entry, via a corresponding face of the FIB entry. The transmission of the content request packet to the provider advertising the content in the FIB entry may be termed as content-level routing. The content in the FIB entry may be aggregated based on various criteria, for example, properties.

In operation 850, the node broadcasts the content request packet within an advertisement area (Ad-area) in which the requester is included. The advertisement area may range from at least one node, in which content of a similar or identical field to the content requested from the requester is stored, to core routers connected to an Internet core on a hierarchical basis. Accordingly, the advertisement area may be used to limit a range of advertising popular content. The term “broadcast” may refer to delivering a packet transmitted from an arbitrary node to all other nodes connected to a router, and may be used to send packets from a source node, via multicast, to nodes in a real or virtual network.

In operation 860, the node determines whether a reply to the broadcast is received. The reply includes the content requested from the requester. When the reply to the broadcast is determined to be received, the node continues in operation 870. Otherwise, the node continues in operation 880.

In operation 870, the node transmits the content requested from the requester to the requester.

In operation 880, the node transmits the content request packet to a publisher. The node may transmit the content request packet directly to the publisher, using longest prefix matching, e.g., a longest prefix of a hierarchical name of the content that is included in the content request packet and that is a routing path to the publisher. The transmission of the content request packet to the publisher may be termed publisher-level routing.

For unpopular information less useful for content-level routing, publisher-level routing may allow transmission of a content request packet to a publisher through shortest path routing, absent advertising the content. The content may be aggregated by an organization hierarchy of the publisher.

That is, publisher-level routing may refer to a transmission of a content request packet to a publisher to request the publisher to transmit the content when the content is determined to be absent in a local area within a domain, for example, a discovery area. The publisher may be called an author or owner of the content.

For example, when a user node accesses a streaming video site server Sy through routers Ra, Rb, and Rc to search for content “abc.avi”, the streaming video site server Sy may be a publisher. Even though a file or the content “abc.avi” is present in content caches of the routers Ra, Rb, and Rc, each of the routers Ra, Rb, and Rc may not be a publisher of the content “abc.avi” because each of the routers Ra, Rb, and Rc are not an originator.

A further detailed description of content-level routing and publisher-level routing is provided below. For example, in an example in which a node A owns a file or content “/kbs.com/art/music/1st week/#1song.mp3”, the node A may advertise information of the content when the content is very popular. Also, a node B residing in the same domain as the node A may receive an advertisement for the content.

When the node B receives a packet requesting the content “/kbs.com/art/music/1st week/#1song.mp3”, the node B may transmit a packet requesting the content “/kbs.com/art/music/1st week/#1song.mp3” to the node A. Since the content was advertised, and the content request packet may be routed using the advertisement for the content. Hence, content-level routing may be used.

When the file or content “/kbs.com/art/music/1st week/#1song.mp3” becomes unpopular two weeks after the advertisement for the content, and the node A deletes the file, the node B may not know where to transmit a content request packet due to a failure of advertising the content from the node A, even though the node B receives the content request packet. In this example, the node B may test whether routing paths are present for the following content names or prefixes, in a sequential order.

/kbs.com/art/music/1st week/#1song.mp3
/kbs.com/art/music/1st week/
/kbs.com/art/music/
/kbs.com/art/
/kbs.com/

When the routing paths for the above content names or prefixes are not found, the node B may transmit the content request packet to an originator, namely, a publisher “/kbs.com/”. As described in the foregoing, publisher-level routing may refer to a transmission of a content request packet directly to a publisher. That is when content is not advertised, longest prefix matching may be executed in the above sequential order to determine whether a routing path for a name of the content is present. Accordingly, more efficient routing in a domain may be achieved by switching to publisher-level routing when content that a user intends to find through content-level routing is absent in a local area within a domain.

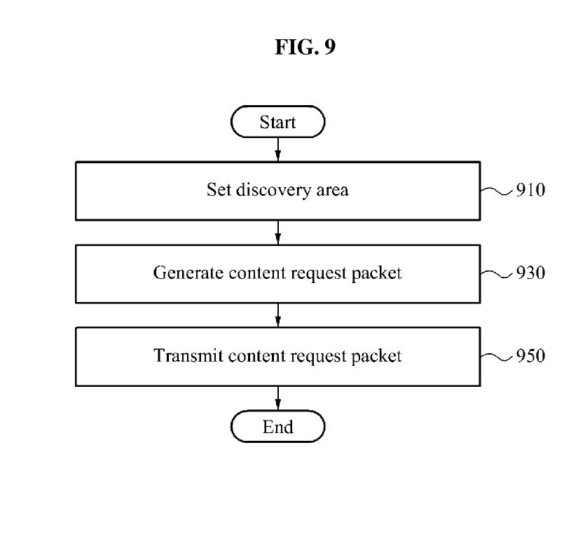

FIG. 9 illustrates an example of a method for content discovery of a node in a CCN. Referring to FIG. 9, in operation 910, the node sets a discovery area. The discovery area is an area in which a search for content requested from the node is to be conducted. The content may include information of devices included in the CCN and information being served by each device, as well as the content requested from the node. The node may set the discovery area based on an area input from a customer equipment (CE) device included in the CCN, or an area set as a default. The discovery area may range from another node, in which content of a similar or identical field to the content requested from the node is stored, to core routers. The core routers may be connected to an Internet core on a hierarchical basis. The discovery area may be set freely as requested from a user, for example, Home, Home/Room1, or Home/Room2.

In operation 930, the node generates a content request packet including the set discovery area. The content request packet may further include an operation ID (OID) designating a control operation to be performed by another node in the discovery area in response to the content request packet being received. Using the operation ID, the node may designate the control operation, for example, content discovery, content storage, content deletion, content copying, content updating, content forwarding, content splitting, content combination, content encoding, content decoding, and content encryption.

In operation 950, the node transmits the generated content request packet, e.g., to the other node in the discovery area. The node may be a device included in a CCN, for example, a CE device and/or an access point. The CE device may include, user terminals, for example, smart phones, smart TVs, personal computers (PCs), laptop computers, robot cleaners, and/or other terminals known to one of ordinary skill in the art. A CCN application may be installed in the node. All overlay CCN devices including an access point may be assigned a hierarchical name such as, for example, “ccn://Home/Room1/AP1”. In contrast, a CE device may be assigned a non-hierarchical name such as, for example, “phone”, “laptop”, and/or “device”.

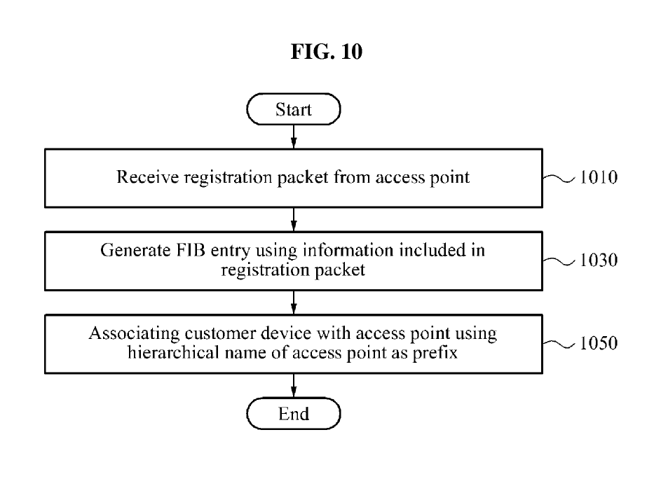

FIG. 10 illustrates an example of a method of forming an association with an access point in a CCN. Hereinafter, a node is a CE device, and the method of FIG. 10 may be performed before the method of FIG. 9.

Referring to FIG. 10, in operation 1010, the node receives, from the access point, a registration packet requesting registration of the access point with the node. The registration packet may include a hierarchical name of the access point requesting the registration of the access point with the node, and information of a discovery area to which the registration packet is transmitted.

In operation 1030, the node generates an FIB entry using the information included in the registration packet. The node registers the hierarchical name of the access point that is included in the registration packet, to be in the FIB entry of the node.

In operation 1050, the node forms the association with the access point, using the hierarchical name of the access point as a prefix. For example, if a name assigned to the node is “phone”, and the hierarchical name of the access point with which the node intends to associate is “ccn://Home/Room1/AP1”, the node generates a full name of the node “ccn://Home/Room1/AP1/phone” using the hierarchical name of the access point “ccn://Home/Room1/AP1” as a prefix. The node may generate a face between the node and the access point, using the generated full name.

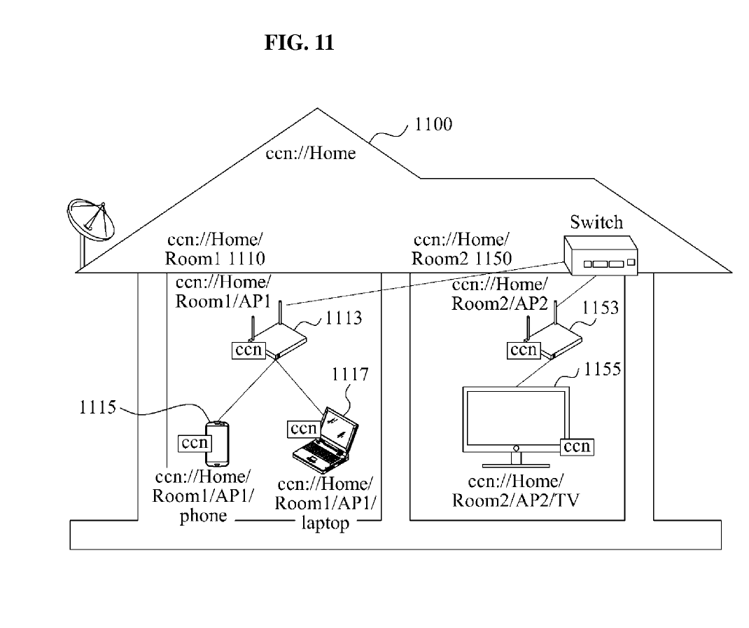

FIG. 11 illustrates an example of an operation of a node for content discovery over a native L2 in a CCN. Referring to FIG. 11, an application to be used with the CCN over a native L2 stack, namely, a CCN stack, is installed on all devices, including access points, in the CCN.

In a home 1100, a phone 1115 associated with an access point 1 AP1 1113 of a Room1 1110 discovers a TV 1155 associated with an access point 2 AP2 1153 of a Room2 1150 through the following method. A user assigns an appropriate hierarchical name (e.g., “/Home/Room1/AP1”) to all devices, including the access points, in the CCN. A CE device may be assigned a non-hierarchical name, such as, for example, “phone”, “laptop”, and “TV”. When an access point is associated with a CE device, the CE device may use a name of the access point as a prefix of the CE device. For example, a full name of the phone 1115 may be “ccn://Home/Room1/AP1/phone”.

The access point 1 AP1 1113 and the access point 2 AP2 1153 generate a face between the access point 1 AP1 1113 and the access point 2 AP2 1153. Further, each of the access point 1 AP1 1113 and the access point 2 AP2 1153 may transmit a registration packet. Each of the access point 1 AP1 1113 and the access point 2 AP2 1153 may transmit the registration packet via a CCN broadcast. The CCN broadcast may be a transmission of a content request packet, including a name of a target device to be registered and a registration range. The name of the target device to be registered may be, for example, “ccn://Home/Room 1/AP1”, and the registration range may be set to, for example, “ccn://Home”.

Each of the access point 1 AP1 1113 and the access point 2 AP2 1153 generates a face between the corresponding access point and a CE device associated with the access point, and the face may be used to transmit a content request packet. For example, the phone 1115 may transmit a content request packet for device discovery. The phone 1115 or a user of the phone 1115 may set a name of content requested for discovery to “ccn://Home” or “ccn://Home/Room 1” flexibly, as needed. An operation ID included in the content request packet may be set to “DEVICE_DISCOVERY”. If the phone 1115 transmits the content request packet based on “ccn://Home/Room 1”, only a laptop computer 1117 associated with the access point 1 AP1 1113 of the Room1 1110 may make a reply. Also, when the phone 1115 transmits the content request packet based on “ccn://Home”, the laptop computer 1117 included in the Room1 1110 and the TV 1155 included in the Room2 1150 may make a reply. The phone 1115 may discover the laptop computer 1117 and the TV 1155 included in the Home 1100 based on the reply.

Accordingly, an access point and other devices in a local environment may discover a device associated with a different access point flexibly, by installing an application to be used with a CCN stack on nodes included in a CCN. Also, the access point and the other device may discover contents, services, and/or information. A user may set or change a discovery area flexibly by setting a name of a content request packet differently as needed.

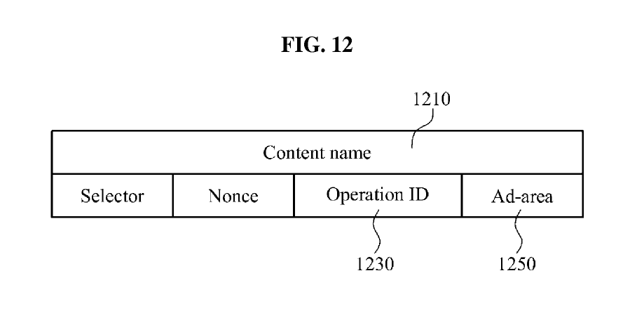

FIG. 12 illustrates an example of a format of a content request packet based on a method of discovering content from a node in a CCN. Referring to FIG. 12, the content request packet includes a content name field 1210, an operation ID field 1230, and an Ad-area field 1250.

The content name field 1210 may include a name of content, information, and/or a device requested through the content request packet. The content name field 1210 may be used to locate the content, the information, and/or the device requested from a user, and to indicate a discovery area in which content discovery is to be executed.

The operation ID field 1230 may indicate an objective of the content request packet, or a control operation to be performed by a device receiving the content request packet in the discovery area. The operation ID field 1230 may be set to, for example, “DEVICE_DISCOVERY”.

The Ad-area field 1250 may indicate a range, for example, “ccn://Home”, to which the content request packet is applied, for example, a range in which a control operation corresponding to the operation ID field 1230 is to be performed by a device receiving the content request packet. An Ad-area may be understood to be identical to the discovery area. The discovery area may be set flexibly by a user based on the content name. The user may change the discovery area flexibly by representing, as a name, a range in which a search is to be conducted in a header field of a content request packet, for example, an interest.

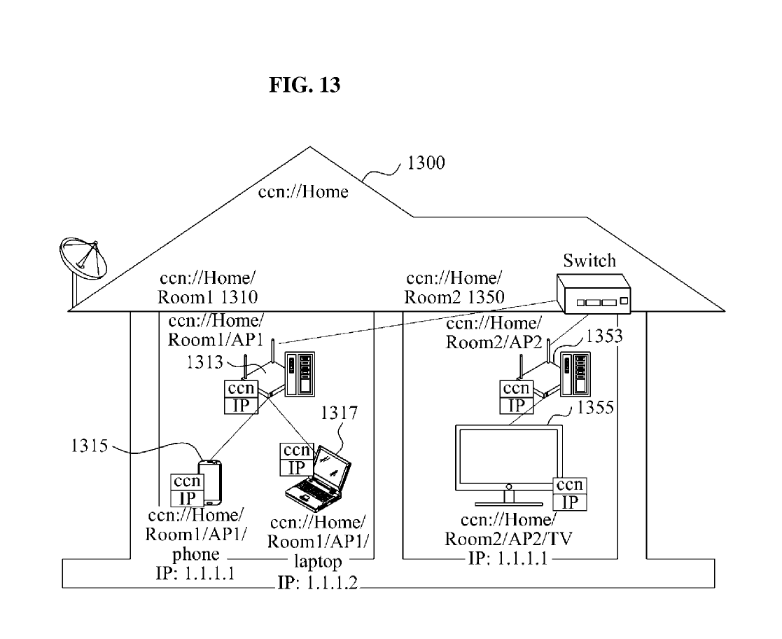

FIG. 13 illustrates an example of an operation of a node for content discovery over an IP in a CCN. Referring to FIG. 13, the CCN over an IP stack, also referred to as a CCN application, is used or installed on all devices included in the CCN.

In a home 1300, a phone 1315 associated with an access point 1 AP1 1313 of a room 1 1310 may discover a TV 1355 associated with an access point 2 AP2 1353 of a room 2 1350 through the following method. A user may set a name of a device, including an access point, in the CCN. All of the devices, including the access points, in the CCN may be assigned an appropriate hierarchical name, e.g., “/Home/Room1/AP1/”. In contrast, a CE device may be assigned a non-hierarchical name, such as, for example, “phone”, “laptop”, and “TV”.

Subsequently, the access point 1 AP1 1313 located in the room 1 1310 and the access point 2 AP2 1353 located in the room 2 1350 generate a face between the access point 1 AP1 1313 and the access point 2 AP2 1353. Further, each of the access point 1 AP1 1313 and the access point 2 AP2 1353 may transmit a registration packet of the corresponding access point. Each of the access point 1 AP1 1313 and the access point 2 AP2 1353 may transmit the registration packet via an IP broadcast.

Each access point may set an external IP of the access point to be an endpoint. The endpoint may be an actual address of a layer 3 or network layer. The IP address may be an endpoint because an IP layer is used. A broadcast traffic may be transmitted because external IPs of the two access points are within a local area network (LAN) segment.

When an association between an access point and a CE device is formed, the CE device may use a name of the access point as a name of the CE device. For example, a full name of the phone 1351 may be “ccn://Home/Room 1/AP1/phone”.

Each of the access point 1 AP1 1313 and the access point 2 AP2 1353 generates a face between the corresponding access point and a CE device associated with the access point, and the face may be used to transmit a content request packet. For example, the phone 1315 may transmit a content request packet for device discovery. The phone 1315 or a user of the phone 1315 may set a name of content requested for search to “ccn://Home” or “ccn://Home/Room 1” flexibly, as needed. An operation ID included in the content request packet may be set to “DEVICE_DISCOVERY”. If the phone 1315 transmits the content request packet based on “ccn://Home/Room1”, only a laptop computer 1317 included in the Room 1 1310 may make a reply. Also, if the phone 1315 transmits the content request packet based on “ccn://Home”, the laptop computer 1317 included in the Room 1 1310 and the TV 1355 included in the Room 2 1350 may make a reply. Accordingly, the phone 1315 may discover the laptop computer 1317 and the TV 1355 included in the Home 1300 based on the reply.

When an IP router is used in an environment of FIG. 13, a packet may be transmitted absent using a session initiation protocol (SIP) server for association between devices. When an external IP of the access point 1 AP1 1313 is identical to an external IP of the access point 2 AP2 1353, at least two thirds of CCN devices may be provided between the access point 1 AP1 1313 and the access point 2 AP2 1353 to prevent a collision between the IPs.

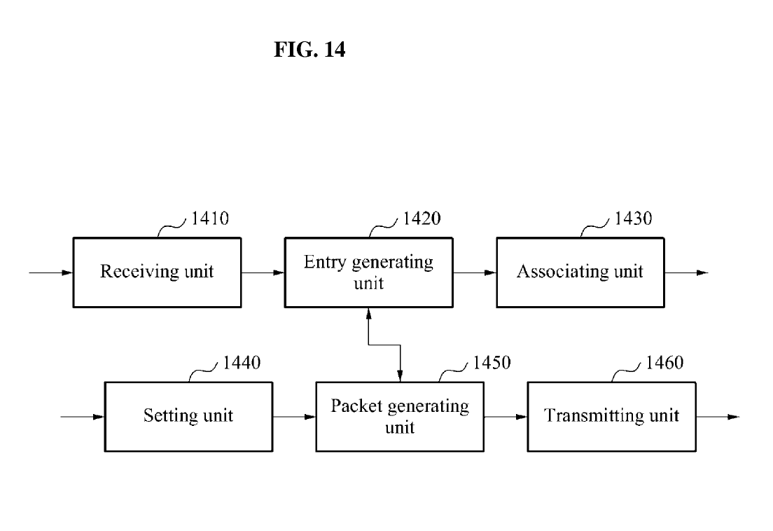

FIG. 14 illustrates an example of a node for content discovery in a CCN. Referring to FIG. 14, the node includes a receiving unit 1410, an entry generating unit 1420, an associating unit 1430, a setting unit 1440, a packet generating unit 1450, and a transmitting unit 1460.

The node may include a device included in the CCN, such as, for example, a CE device, an access point, and/or other devices known to one of ordinary skill in the art. The CE device may include a user terminal, for example, a smartphone, a smart TV, a PC, a laptop computer, a robot cleaner, and/or other terminals known to one of ordinary skill in the art. An application for the CCN may be installed on the node.

The receiving unit 1410 receives, from an access point, a registration packet requesting registration of the access point with the node. The registration packet may include a hierarchical name of the access point requesting the registration of the access point with the node, and information of a discovery area to which the registration packet is transmitted.

The entry generating unit 1420 generates an FIB entry based on the information included in the registration packet.

The associating unit 1430 associates the node with the access point, using the hierarchical name of the access point as a prefix. The associating unit 1430 may obtain the hierarchical name of the access point from the registration packet received by the receiving unit 1410 or the FIB entry generated by the entry generating unit 1420.

The setting unit 1440 sets a discovery area. The discovery area may be an area in which a search for content requested from the node is to be conducted. The setting unit 1440 may set the discovery area based on an area input from a CE device included in the CCN, or an area set as a default.

The packet generating unit 1450 generates a content request packet including the set discovery area in which the search for the content requested from the node included in the CCN is to be conducted. The content may include information of devices in which the content is stored, information being served by each device, and the content requested from the node. The content request packet may include an operation ID (OID) designating a control operation to be performed by another node receiving the content request packet in the discovery area. Using the operation ID, the node may designate a control operation, for example, content discovery, content storage, content deletion, content copying, content updating, content forwarding, content splitting, content combination, content encoding, content decoding, and/or content encryption. The discovery area may range from another node, in which content of a similar or identical field to the content requested from the node is stored, to one or more core routers. The core routers may be connected to an Internet core on a hierarchical basis.

The transmitting unit 1460 transmits the content request packet generated by the packet generating unit 1450 to, e.g., the other node in the discovery area.

The various units, modules, elements, and methods described above may be implemented using one or more hardware components, one or more software components, or a combination of one or more hardware components and one or more software components.

A hardware component may be, for example, a physical device that physically performs one or more operations, but is not limited thereto. Examples of hardware components include microphones, amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may include various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions that control a processing device to implement a software component may include a computer program, a piece of code, an instruction, or some combination thereof, that independently or collectively instructs or configures the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments that implement the examples disclosed herein can be easily constructed by a programmer skilled in the art to which the examples pertain based on the drawings and their corresponding descriptions as provided herein.

As a non-exhaustive illustration only, a terminal or device described herein may be a mobile device, such as a cellular phone, a personal digital assistant (PDA), a digital camera, a portable game console, an MP3 player, a portable/personal multimedia player (PMP), a handheld e-book, a portable laptop PC, a global positioning system (GPS) navigation device, a tablet, a sensor, or a stationary device, such as a desktop PC, a high-definition television (HDTV), a DVD player, a Blue-ray player, a set-top box, a home appliance, or any other device known to one of ordinary skill in the art that is capable of wireless communication and/or network communication.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method for content discovery of a node in an intra-domain in a content centric network (CCN), the method comprising:
generating a content request packet comprising a discovery area in which a search for content requested from the node is to be conducted; and
transmitting the content request packet.

2. The method of claim 1, further comprising:
setting the discovery area.

3. The method of claim 2, wherein the setting of the discovery area comprises:
setting the discovery area based on an area input from a customer equipment (CE) device in the CCN, or an area set as a default.

4. The method of claim 1, further comprising:
determining whether the content requested from a requester is advertised based on an entry of a forwarding information base (FIB).

5. The method of claim 4, wherein the transmitting of the content request packet comprises:
transmitting the content request packet via a face of the entry to a provider advertising the content in response to the content being determined to be advertised.

6. The method of claim 4, wherein the transmitting of the content request packet comprises:
broadcasting the content request packet within the discovery area in which the requester is included in response to the content being determined to not be advertised.

7. The method of claim 6, further comprising:
determining whether a reply to the broadcasting is received,
wherein the transmitting of the content request packet comprises transmitting the content request packet to a publisher of the content in response to the reply to the broadcasting being determined to be not received.

8. The method of claim 7, wherein the transmitting of the content request packet comprises:
transmitting the content request packet to the publisher, using longest prefix matching.

9. The method of claim 1, further comprising:
receiving information of the content being advertised based on a popularity of the content; and
generating an entry of a forwarding information base (FIB) based on the information of the content.

10. The method of claim 9, wherein the information of the content comprises a list of content names that is stored in a content cache of a provider.

11. The method of claim 9, wherein the popularity of the content is determined based on an access count of the content.

12. The method of claim 1, wherein the content request packet further comprises an operation identification (OID) designating a control operation to be performed by another node in the discovery area in response to the content request packet being received.

13. The method of claim 1, wherein the discovery area ranges from another node, in which content of a similar or identical field to the content requested from the node is stored, to a core router connected to an Internet core on a hierarchical basis.

14. The method of claim 1, wherein the node comprises a customer equipment (CE) device on which an application for the CCN is installed, and/or an access point on which the application is installed.

15. The method of claim 14, wherein the access point comprises a hierarchical name.

16. The method of claim 1, further comprising:
receiving, from an access point, a registration packet requesting registration; and
generating an entry of a forwarding information base (FIB) based on information in the registration packet.

17. The method of claim 16, wherein the registration packet comprises a hierarchical name of the access point, and information of the discovery area to which the registration packet is transmitted.

18. The method of claim 1, further comprising:
associating the node with an access point, using a hierarchical name of the access point as a prefix.

19. A non-transitory computer-readable storage medium storing a program comprising instructions to cause a computer to perform the method of claim 1

20. A method for content discovery of a node in an inter-domain in a content centric network (CCN), the method comprising:
determining whether another domain transmitting a content request packet to the node is associated with a policy;
searching for content stored in the node based on a result of the determination; and
transmitting the content stored in the node in response to the content stored in the node matching content requested from the other domain.

21. The method of claim 20, wherein the content request packet comprises a field indicating a domain by which the content request packet is generated.

22. The method of claim 20, wherein the policy comprises the inter-domain and a domain that are agreed to in a cache look-up contract, or a contract for a cache hit ratio, or a contract for a cache size to be allocated, or any combination thereof.

23. The method of claim 22, wherein the determining comprises:
determining whether the other domain is associated with the policy based on a field indicating a domain that is in the content request packet.

24. The method of claim 20, further comprising:
exchanging, with the other domain, routing information based on the policy, using a sync tree comprising connectivity information between the inter-domain and the other domain.

25. A node for content discovery in an intra-domain in a content centric network (CCN), the node comprising:
a packet generating unit configured to generate a content request packet comprising a discovery area in which a search for content requested from the node is to be conducted; and
a transmitting unit configured to transmit the content request packet.

26. The node of claim 25, further comprising:
a setting unit configured to set the discovery area.

27. The node of claim 26, wherein the setting unit is further configured to:
set the discovery area based on an area input from a customer equipment (CE) device in the CCN, or an area set as a default.

28. The node of claim 25, wherein the content request packet further comprises an operation identification (OID) designating a control operation to be performed by another node in the discovery area in response to the content request packet being received.

29. The node of claim 25, wherein the discovery area ranges from another node, in which content of a similar or identical field to the content requested from the node is stored, to a core router connected to an Internet core on a hierarchical basis.

30. The node of claim 25, wherein the node comprises a customer equipment (CE) device on which an application for the CCN is installed, and/or an access point on which the application is installed.

31. The node of claim 25, further comprising:
a receiving unit configured to receive, from an access point, a registration packet requesting registration; and
an entry generating unit configured to generate an entry of a forwarding information base (FIB) based on information in the registration packet.

32. The node of claim 31, wherein the registration packet comprises a hierarchical name of the access point, and information of the discovery area to which the registration packet is transmitted.

33. The node of claim 25, further comprising:
an associating unit configured to associate the node with an access point, using a hierarchical name of the access point as a prefix.
